(19) United States
(12) Patent Application Publication
(10) Pub. No.: US 2012/0272174 A1
(43) Pub. Date: Oct. 25, 2012

(54) SYSTEM AND METHOD FOR DRILLING A BOREHOLE USING STREAMING REFERENCE DATA

(75) Inventors: Stephen K. VOGEL, Cypress, TX (US); Jamal N. ASKER, Houston, TX (US); William L. KOEDERTIZ, Cedar Park, TX (US)

(73) Assignee: NATIONAL OILWELL VARCO, L.P., Houston, TX (US)

(21) Appl. No.: 13/091,269

(22) Filed: Apr. 21, 2011

(51) Int. Cl. G06F 3/048

(52) U.S. Cl. 715/772

(57) ABSTRACT

A system and method for improving drilling efficiency using drilling efficiency reference from a previously drilled offset well. In one embodiment a method for drilling a borehole includes displaying a graphical representation of drilling efficiency for a previously drilled wellbore. A graphical representation of drilling efficiency for the borehole is also displayed. The displayed drilling efficiency for the previously drilled wellbore is compared to the displayed drilling efficiency for the borehole. Responsive to the comparing, the drilling efficiency for the borehole is adjusted by changing a parameter affecting the drilling of the borehole.

### BACKGROUND

To obtain hydrocarbons such as oil and gas, boreholes are drilled by rotating a drill bit attached to a drill string. The earth-boring drill bit is typically mounted on the lower end of the drill string as part of a bottomhole assembly (BHA) and is rotated by rotating the drill string at the surface or by actuation of downhole motors or turbines, or by both methods. With weight applied to the drill string, the rotating drill bit engages the earthen formation and proceeds to form a borehole toward a target zone.

A number of downhole devices placed in close proximity to the drill bit measure downhole operating parameters associated with the drilling and downhole conditions. Such devices typically include sensors for measuring downhole temperature and pressure, azimuth and inclination measuring devices, and a resistivity-measuring device to determine the presence of hydrocarbons and water. Additional downhole instruments, known as logging-while-drilling (LWD) and/or measurement-while drilling (MWD) tools, are frequently attached to the drill string to determine the formation geology and formation fluid conditions during the drilling operations. The information provided to the operator during drilling usually includes drilling parameters, such as weight-on-bit (WOB), rotational speed of the drill bit and/or the drill string, and the drilling fluid flow rate. In some cases, the drilling operator is also provided selected information from the downhole sensors such as bit location and direction of travel, downhole pressure, and possibly formation parameters such as resistivity and porosity.

Boreholes are usually drilled along predetermined paths, and the drilling of a typical borehole proceeds through various formations. The downhole operating conditions may change and the operator must react to such changes and adjust the surface-controlled parameters to optimize the drilling operations. The drilling operator typically controls the surface-controlled drilling parameters, such as the weight-on-bit (WOB), drilling fluid flow through the drill pipe (flow rate and pressure), the drill string rotational speed (e.g., RPM of the surface motor coupled to the drill string), axial position of the drill string and bit, and the density and viscosity of the drilling fluid to optimize the drilling operations. Thus, in drilling operations, the drilling operator adjusts the various surface-controlled drilling parameters in an attempt to optimize drilling efficiency.

### SUMMARY

A system and method for improving drilling efficiency using drilling efficiency reference from a previously drilled offset well. In one embodiment, a method for drilling a borehole includes displaying a graphical representation of drilling efficiency for a previously drilled wellbore. A graphical representation of drilling efficiency for the borehole is also displayed. The displayed drilling efficiency for the previously drilled wellbore is compared to the displayed drilling efficiency for the borehole. Responsive to the comparing, the drilling efficiency for the borehole is adjusted by changing a parameter affecting the drilling of the borehole.

In another embodiment, a system for drilling a borehole includes a controller configured to control the operation of a drill bit disposed in the borehole. The controller includes a processor, a display device, and a drilling control module. The drilling control module, when executed by the processor, causes the controller to display, on the display device while drilling the borehole, a graphical representation of drilling efficiency for the borehole and to display a graphical representation of drilling efficiency for a previously drilled wellbore

In yet another embodiment, a computer-readable medium is encoded with instructions. When executed, the instructions cause the processor to display a graphical representation of drilling efficiency for a previously drilled wellbore. The instructions also cause the processor to display a graphical representation of drilling efficiency for a borehole currently being drilled. The instructions further cause the processor to synchronize the display of the drilling efficiency for the previously drilled wellbore to the display of drilling efficiency for the borehole based on depth of the borehole.

### BRIEF DESCRIPTION OF THE DRAWINGS

For a detailed description of exemplary embodiments of the invention, reference will now be made to the accompanying drawings in which:

FIG. 1 shows a system for drilling a borehole using streaming reference data in accordance with principles disclosed herein;

FIG. 2 shows a block diagram of a drilling control system that uses streaming reference data in accordance with principles disclosed herein;

FIG. 3 shows an exemplary display of real-time and reference drilling efficiency data provided by the drilling control system of FIG. 2; and

FIG. 4 shows a flow diagram for a method for drilling a borehole using streaming reference data in accordance with principles disclosed herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through direct engagement of the devices or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

When drilling a borehole, an operator attempts to maximize drilling efficiency (e.g., minimize cost of drilling to a target zone) by adjusting various drilling parameters such as weight on bit (WOB), drill string rate of rotation, etc. However, it may be difficult for an operator to determine whether optimum drilling efficiency has been achieved. Embodiments of the present disclosure provide a drilling efficiency reference for comparison with real-time drilling efficiency values generated while drilling a borehole. The streaming drilling efficiency reference is derived from a wellbore previously drilled in an area reasonably proximate to the borehole currently being drilled (i.e., an offset well).

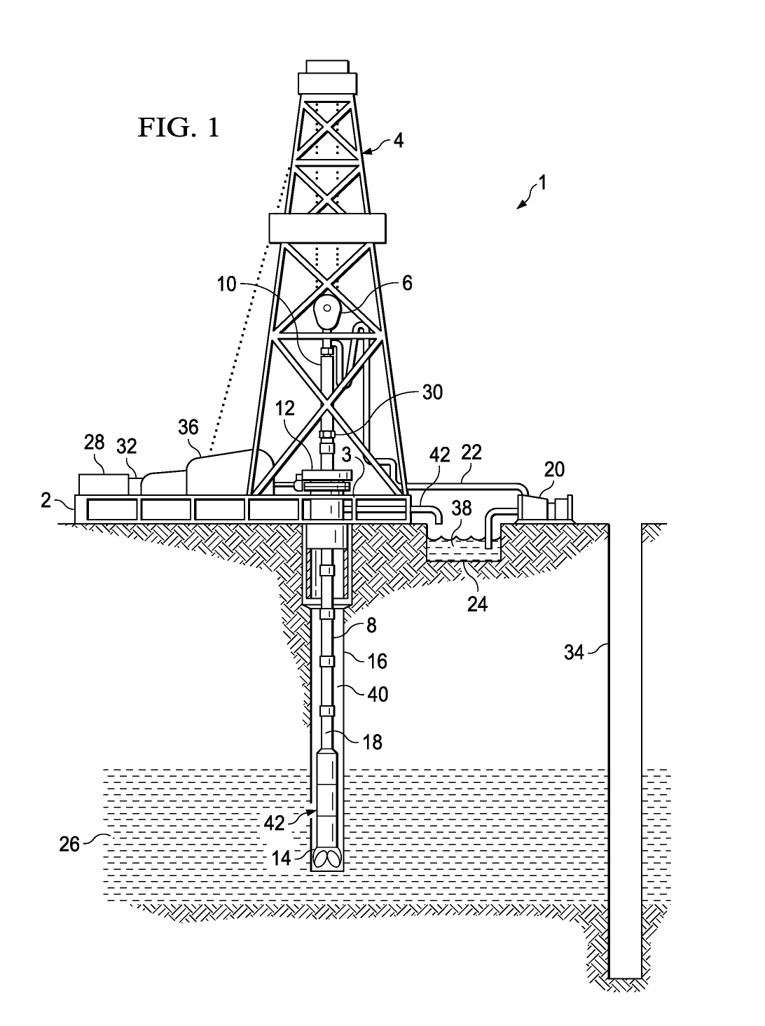

FIG. 1 shows a schematic diagram of an embodiment of a drilling system in accordance with the principles described herein. The drilling system 1 includes derrick 4 supported by a drilling platform 2. The derrick 4 includes a floor 3 and a traveling block 6 for raising and lowering a drill string 8. The derrick supports a rotary table 12 that is rotated by a prime mover such as an electric motor controlled by a motor controller. A kelly 10 supports the drill string 8 as it is lowered through the rotary table 12.

The drill string 8 extends downward through the rotary table 12, and is made up of various components, including drill pipe 18 and components of the bottom hole assembly (BHA) 42 (e.g., bit 14, mud motor, drill collar, tools, etc.). The drill bit 14 is attached to the lower end of the drill string 8. The drill bit 14 disintegrates the subsurface formations 26 when it is rotated with weight-on-bit to drill the borehole 16. The weight-on-bit, which impacts the rate of penetration of the bit 14 through the formations 26, is controlled by a drawworks 36. In some embodiments of the drilling system 1, a top drive may be used to rotate the drill string 8 rather than rotation by the rotary table 12 and the kelly 10. In some applications, a downhole motor (mud motor) is disposed in the drilling string 8 to rotate the drill bit 15 in lieu of or in addition to rotating the drill string 8 from the surface. The mud motor rotates the drill bit 14 when drilling fluid passes through the mud motor under pressure. The rate of penetration (ROP) of the drill bit 14 into the borehole 16 for a given formation largely depends upon the weight-on-bit and the drill bit rotational speed.

As indicated above, during drilling operations a suitable drilling fluid 38 from a mud tank 24 is circulated under pressure through the drill string 8 by a mud pump 20. The drilling fluid 38 passes from the mud pump 20 into the drill string 8 via fluid line 22 and the kelly 10. The drilling fluid 38 is discharged at the borehole bottom through nozzles in the drill bit 14. The drilling fluid 38 circulates to the surface through the annular space 40 between the drill string 8 and the sidewall of borehole 16, and returns to the mud tank 24 via a solids control system (not shown) and a return line 42. The drilling fluid 38 transports cuttings from the borehole 16 into the reservoir 24 and aids in maintaining the borehole integrity. The solids control system separates the cuttings from the drilling fluid 38, and may include shale shakers, centrifuges, and automated chemical additive systems.

Various sensors are employed in drilling system 1 for monitoring a variety of surface-controlled drilling parameters and downhole conditions. For example, a sensor disposed in the fluid line 22 measures and provides information about the drilling fluid flow rate and pressure. A surface torque sensor and a rotational speed sensor associated with the drill string 8 measure and provide information about the torque applied to the drill string 8 and the rotational speed of the drill string 8, respectively. Additionally, a sensor associated with traveling block 6 may be used to measure and provide the hook load of the drill string 8. Additional sensors are associated with the motor drive system to monitor proper drive system operation. These include, but are not limited to, sensors for detecting such parameters as motor speed (RPM), winding voltage, winding resistance, motor current, and motor temperature. Other sensors are used to indicate operation and control of the various solids control equipment.

The bottom hole assembly 42 may also include a measurement-while-drilling and/or a logging-while-drilling assembly containing sensors for determining drilling dynamics, drilling direction, formation parameters, downhole conditions, etc. Outputs of the sensors may be transmitted to the surface using any suitable downhole telemetry technology known in the art (e.g., wired drill pipe, mud pulse, etc).

Outputs from the various sensors are provided to a drilling control system 28 via a connection 32 that may be wired or wireless. The drilling control system 28 controls the various parameters of the drilling process ((e.g., applied torque and rotational speed of the drill string, the axial position and speed of the drill string, weight-on-bit, the pressure and flow rate of the drilling fluid, etc). For example, the drilling control system 28 may control the drawworks 38, a prime mover, a top drive, the mud pump 20 etc. The drilling control system 28 processes the sensor outputs to derive a measure of drilling efficiency for the borehole 16. Some embodiments of the drilling control system 28 compute mechanical specific energy (MSE) as a measure of drilling efficiency as is known in the art. MSE may be computed as:

$$MSE = {E}_{m} ( \frac{4 WOB}{1000 {D}^{2} π} + \frac{480 {N}_{b} T}{1000 {D}^{2} ROP} )$$

where

Eₘ is mechanical efficiency;

WOB is weight on bit;

N_{b} is bit rotational speed;

D is bit diameter;

T is drill string torque; and

ROP is rate of penetration.

WOB, D, N_{b}, T, and ROP can be derived from sensor outputs, and Eₘ may be supplied by a user. Some embodiments of the drilling control system 28 may compute MSE differently or compute a different measure of drilling efficiency. The drilling control system 28 is configured to display the computed measure of drilling efficiency for examination by a drilling operator.

The drilling control system 28 is configured to display, concurrent with the display of the drilling efficiency of the borehole 16, a measure of drilling efficiency of a previously drilled offset well 34. The particular offset well 34 may be selected as a source of drilling efficiency data based on the well having similar characteristics to those expected of the borehole 16 (e.g., similar formations, drilling problems, etc). The drilling efficiency displays are depth-synchronized such that for each depth at which a drilling efficiency value is displayed for the borehole 16, a corresponding drilling efficiency value for that depth is displayed for the offset well 34. The drilling efficiency displays may be overlayed or be disposed proximate to one another to facilitate comparison of drilling efficiency of the borehole 16 to that of the offset well 34.

The drilling efficiency of the offset well provides a baseline for drilling efficiency of the borehole 16. Comparison of the drilling efficiencies indicates whether adjustment of the drilling parameters is desirable to improve drilling efficiency for the borehole 16. For example, if the MSE achieved when drilling the offset well 34 at a given depth is lower than the MSE achieved when drilling the borehole 16 at that depth (indicating that higher drilling efficiency is possible because the drilling efficiency of the offset well is higher than that of the borehole 16), then the drilling operator may adjust, for example, WOB, and/or N_{b}, and/or a different drilling control parameter to improve the drilling efficiency of the borehole 16. Thus, embodiments of the present disclosure provide guidance to the drilling operator with regard to drilling efficiency in the form of streaming reference efficiency data derived from the offset well 34.

During drilling of the offset well 34, data may be omitted or replaced by previous acquired values due to drilling system failures, such as telemetry drop-out, sensor malfunction, etc. The offset well efficiency data is processed to remove anomalous values, such as duplicate values and null values, and depth corrections are applied to the data to account for differences in geology and well deviation. The processed efficiency data is stored in the drilling control system 28 or at a storage location accessible by the drilling control system 28 (e.g., via network).

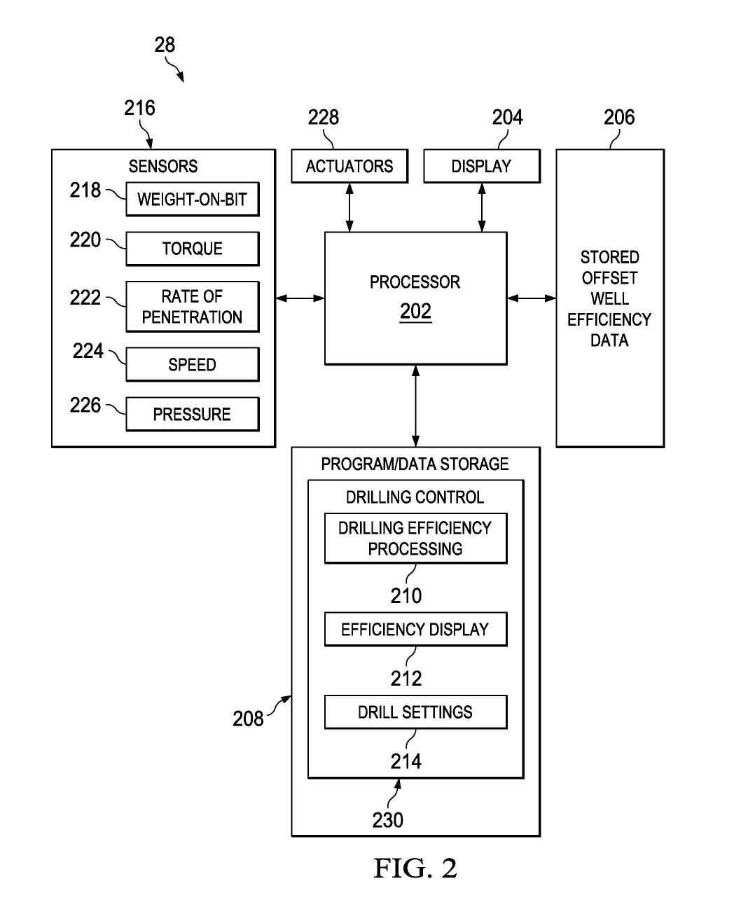

FIG. 2 shows a block diagram of the drilling control system 28 configured to use streaming reference data in accordance with principles disclosed herein. The drilling control system 28 includes a processor 202, a display device 204, and program/data storage 208. The processor 202 is also coupled to the various sensors 216 and actuators 228 of the drilling system 1, and to the stored offset well drilling efficiency data 206. In some embodiments of the drilling control system 28 the processor 202 and program/data storage 208 may be embodied in computer, such as a desktop computer, notebook computer, a blade computer, a server computer, or other suitable computing device known in the art.

The actuators 228 include mechanisms and/or interfaces that are controlled by the processor 202 to affect drilling operations. For example, the processor 202 may control rotation speed of the drill string 8 by controlling an electric motor through a motor controller, or may similarly control weight-on-bit by controlling a motor in the drawworks 36. Various other types of actuators controlled by the processor 202 include solenoids, telemetry transmitters, valves, etc.

The display 204 includes one or more display devices used to convey information to a drilling operator. The display 204 may be implemented using one or more display technology known in that art, such as liquid crystal, cathode ray, plasma, organic light emitting diode, vacuum fluorescent, electroluminescent, electronic paper or other display technology suitable for providing information to a user.

The sensors 216 are coupled to the processor 202, and, as discussed above, include sensors for measuring various drilling system operation parameters used by the processor 202 to determine drilling efficiency (e.g., MSE). Weight-on-bit sensors (e.g., a strain gauges) coupled to the traveling block 6 or disposed in the BHA 42 measure the portion of the weight of the drill string 8 applied to the drill bit 14. Torque sensors (e.g., strain gauges) coupled to the drill string 8 measure the torque applied to the drill string 8. Rate of penetration sensors detect motion of the traveling block 6 and/or extension of the line supporting the traveling block 6, or other indications of the drill string 8 descending into the borehole 16. Speed sensors 224 (e.g., angular position sensors) disposed in the BHA or at the surface detect rotational speed of the drill bit 14. Pressure sensors 226 measure the drilling fluid pressure.

The processor 202 is configured to execute instructions retrieved from storage. The processor 202 may include any number of cores or sub-processors. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

Software programming including instructions executable by the processor 202 is stored in the program/data storage 208. The program/data storage 208 is a computer-readable medium. Computer-readable storage media include volatile storage such as random access memory, non-volatile storage (e.g., ROM, PROM, a hard drive, an optical storage device (e.g., CD or DVD), FLASH storage, or combinations thereof. The program/data storage 208 includes a drilling control module 230 that when executed causes the processor 202 to control drilling operations. The drilling control module 230 includes a drilling efficiency processing module 210 that includes instructions that when executed cause the processor 202 to compute a drilling efficiency measurement value, such as MSE, based on the measurements provided by the sensors 216. For each efficiency measurement value generated for the borehole 16, the efficiency processing module 210 may retrieve an efficiency value for the offset well 34 from the stored offset well efficiency data 206. The retrieved offset well efficiency value corresponds in depth to the computed borehole 16 drilling efficiency value. The stored offset well efficiency data 206 may be located local to the processor 202 (e.g., in storage disposed proximate to the drilling system 1) or remote from the processor 202 and accessed via a communication network (e.g., the internet).

An efficiency display module 212 includes instructions that when executed cause the processor 202 to render a display of the borehole efficiency measurement value generated by the drilling efficiency processing module 212, and the depth correspondent offset well efficiency value retrieved from the stored offset efficiency data 206. The efficiency display module 212 may render the efficiency values in graphical or textual form. In some embodiments, the efficiency values are graphically displayed as an offset well efficiency reference trace overlaying a borehole efficiency trace, and/or as a numeric value representative of efficiency at a given depth (e.g., current borehole depth).

A drill settings module 214 includes instructions that when executed cause the processor 202 to manipulate the actuators 228 to control the drilling operation. The drill settings module 214 may also provide a control interface (e.g., via the display 204) and a user input device (e.g., keyboard, mouse, trackball, touchscreen, motion sensors, etc) that allows a drilling operator to enter drilling control information into the drilling control system 28. For example, the drill settings module 214 may provide a user interface that allows the drilling operator to change WOB, drill string RPM, etc. based on a comparison of the offset well drilling efficiency showing that drilling efficiency of the borehole 16 can be improved.

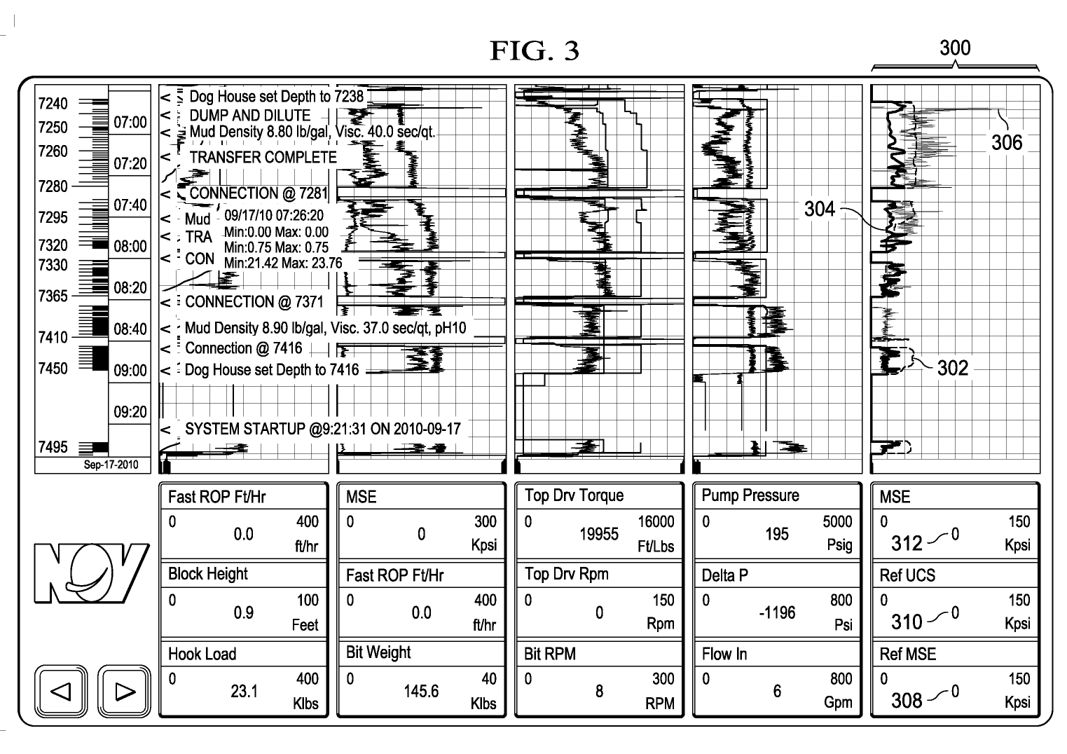

FIG. 3 shows an exemplary display 300 of real-time and reference drilling efficiency data provided by the drilling control system 28. In the display 300 the drilling control system 28 provides reference MSE data, reference unconfined compressive strength (UCS) data, and real-time MSE data. The reference MSE data and reference UCS data are derived from data acquired while drilling the offset well 34. The real-time MSE data is computed and displayed while drilling the borehole 16. The display includes depth synchronous reference MSE 302, reference UCS 304, and real-time MSE 306 traces, and numeric displays of reference MSE 308, reference UCS 310, and real-time MSE 312 values at the current borehole, or a selected, depth. Comparison of the reference efficiency data with the real-time efficiency data allows the drilling operator to determine whether the current drilling operation is less efficient than that of the offset well 34 on an instantaneous and depth correlated basis. Based on the comparison, the drilling operator can adjust one or more drilling parameters with the goal of achieving at least the drilling efficiency exhibited in drilling the offset well 34.

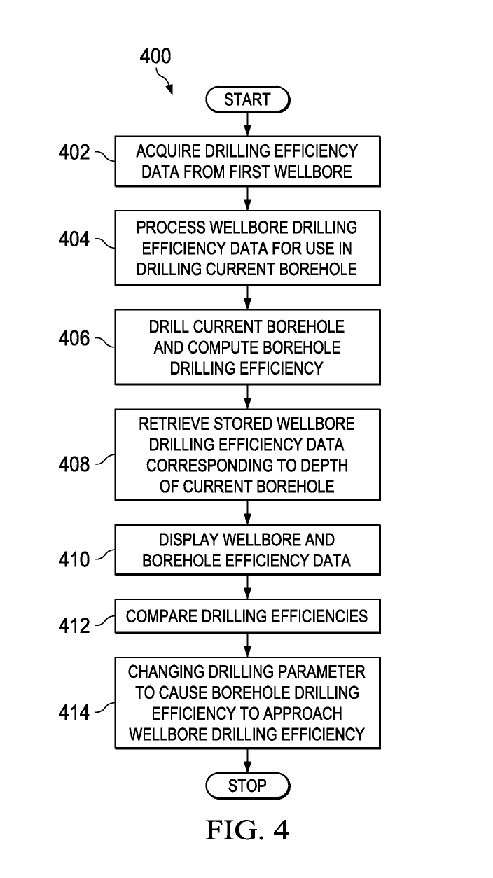

FIG. 4 shows a flow diagram for a method 400 for drilling a borehole using streaming reference data in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of the method 400, as well as other operations described herein, can be implemented by the processor 202 executing instructions stored in a computer readable medium (e.g., storage 208).

In block 402, a first wellbore (e.g., the offset well 34) is drilled. As the wellbore is drilled, drilling efficiency data, or data from which drilling efficiency can be derived, is acquired and stored. Such data may include MSE, and/or the drilling parameters used to compute MSE, and/or offset well log data from which formation mechanical properties (e.g., UCS) can be derived.

The offset well data is processed, in block 404, to produce reference drilling efficiency data that can be used as a baseline for drilling efficiency of the current borehole (e.g., borehole 16). Reference drilling efficiency may be expressed as mechanical specific energy in some embodiments. The data may be processed to remove duplicate values and/or null values, and/or depth corrected for correspondence with the current borehole. The reference data is stored at a location accessible by the drilling control system 28 while drilling the current borehole 16. The storage location may be local to or remote from the drilling control system 28. For example, the reference data may be stored in a database located at a data center and accessible to the drilling control system 28 via network.

In block 406, drilling operations are performed and the current borehole 16 is drilled. Sensors disposed on the drilling system 1 gather information about the drilling operation, and provide the information to the drilling control system 28. The information may comprise, for example, the values discussed above with regard to determining drilling efficiency. Based on the sensor outputs, the drilling control system 28 computes a real-time drilling efficiency value for the current borehole. Real-time drilling efficiency may be expressed as mechanical specific energy in some embodiments.

In block 408, the drilling control system 28 determines the depth of the current borehole and retrieves a stored reference drilling efficiency value corresponding to the depth. The reference drilling efficiency value and the real-time drilling efficiency value are presented on the display device 204 in block 410. The efficiency values may be displayed as overlaying graphical traces on single depth/efficiency range scale.

In block 410, the reference drilling efficiency and the real-time drilling efficiency are compared. If the reference efficiency is higher than the real-time efficiency (e.g., the reference MSE is lower than the real-time MSE), then the drilling operation may be optimized to move real-time drilling efficiency towards the reference drilling efficiency. To effectuate such optimization, in block 414, a drilling parameter (e.g., weight-on-bit, bit rotational speed, etc.) is changed to cause the drilling efficiency of the borehole to approach the drilling efficiency of the offset wellbore.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for drilling a borehole, comprising:
displaying, by a computer, a graphical representation of drilling efficiency for a previously drilled wellbore;
displaying, by the computer, a graphical representation of drilling efficiency for the borehole;
comparing the displayed drilling efficiency for the previously drilled wellbore to the displayed drilling efficiency for the borehole; and
adjusting, responsive to the comparing, the drilling efficiency for the borehole by changing a parameter affecting the drilling.

2. The method of claim 1, further comprising causing the displayed drilling efficiency for the borehole to move towards the displayed drilling efficiency for the previously drilled wellbore responsive to the adjusting.

3. The method of claim 1, further comprising synchronizing the displaying of the drilling efficiency for the previously drilled wellbore to the display of drilling efficiency for the borehole based on depth of the borehole.

4. The method of claim 1, further comprising retrieving a stored value indicative of the drilling efficiency for the previously drilled wellbore at a depth corresponding to a current depth of the borehole.

5. The method of claim 1, wherein drilling efficiency is represented as mechanical specific energy.

6. The method of claim 1, wherein displaying drilling efficiency of the wellbore comprises displaying at least one of mechanical specific energy and unconfined compressive strength.

7. The method of claim 1, wherein comparing comprises determining whether the drilling efficiency for a previously drilled wellbore is greater than the drilling efficiency for the borehole.

8. The method of claim 1, wherein changing a parameter comprises changing at least one of an amount of weight applied to a drill bit and rotation speed of the drill bit.

9. The method of claim 1, further comprising removing at least one of duplicate values and null values from efficiency data acquired while drilling the previously drilled wellbore to generate the drilling efficiency of the previously drilled wellbore.

10. The method of claim 1, further comprising depth correcting the efficiency data acquired while drilling the previously drilled wellbore to generate the drilling efficiency of the previously drilled wellbore, wherein the correcting accounts for differences in deviation between the borehole and the previously drilled wellbore.

11. A system for drilling a borehole, comprising:
a controller configured to control the operation of a drill bit disposed in the borehole, the controller comprising:
a processor;
a display device; and
a drilling control module;
wherein the drilling control module, when executed by the processor, causes the controller to display, on the display device while drilling the borehole, a graphical representation of drilling efficiency for the borehole and a graphical representation of drilling efficiency for a previously drilled wellbore.

12. The system of claim 11, wherein the drilling control module causes the controller to overlay the graphical representation of drilling efficiency for the previously drilled wellbore on the graphical representation of drilling efficiency for the borehole.

13. The system of claim 11, wherein the drilling control module causes the controller to depth synchronize the graphical representation of drilling efficiency for the previously drilled wellbore and the graphical representation of drilling efficiency for the borehole based on the depth of the borehole.

14. The system of claim 11, wherein the drilling control module causes the controller to display drilling efficiency of the previously drilled wellbore as at least one of mechanical specific energy and unconfined compressive strength.

15. The system of claim 11, wherein the drilling control module causes the controller to change a value of a parameter affecting the drilling of the borehole, thereby causing the graphical representation of drilling efficiency for the borehole to move towards the graphical representation of drilling efficiency for the previously drilled wellbore.

16. A non-transitory computer-readable medium encoded with instructions that when executed cause a processor to:
display a graphical representation of drilling efficiency for a previously drilled wellbore;
display a graphical representation of drilling efficiency for a borehole currently being drilled;
synchronize the display of the drilling efficiency for the previously drilled wellbore to the display of drilling efficiency for the borehole based on depth of the borehole.

17. The computer-readable medium of claim 16, wherein the instructions, when executed, cause the processor to retrieve a stored value indicative of the drilling efficiency for the previously drilled wellbore at a depth corresponding to a current depth of the wellbore.

18. The computer-readable medium of claim 16, wherein the instructions, when executed, cause the processor to remove duplicate values and null values from efficiency data acquired while drilling previously drilled wellbore to generate the drilling efficiency for the previously drilled wellbore.

19. The computer-readable medium of claim 16, wherein the instructions, when executed, cause the processor to adjust the drilling efficiency of the borehole by changing a value of a parameter affecting drilling.

20. The computer-readable medium of claim 19, wherein the instructions, when executed, cause the processor to the compute drilling efficiency for the borehole and the drilling efficiency for the previously drilled wellbore as mechanical specific energy.
